(19) United States
(12) Patent Application Publication
(10) Pub. No.: US 2015/0089058 A1
(43) Pub. Date: Mar. 26, 2015

(54) SYSTEM AND METHOD FOR SOFTWARE DEFINED ADAPTATION OF BROADBAND NETWORK GATEWAY SERVICES

(71) Applicant: ALCATEL LUCENT USA, INC., Murray Hill, NJ (US)

(72) Inventor: JUN HU, MOUNTAIN VIEW, CA (US)

(73) Assignee: ALCATEL LUCENT USA, INC., Murray Hill, NJ (US)

(21) Appl. No.: 14/037,518

(22) Filed: Sep. 26, 2013

(51) Int. Cl. H04L 12/24

(52) U.S. Cl. CPC H04L 41/00
USPC 709/225; 709/223

(57) ABSTRACT

Various exemplary embodiments relate to a method performed by a broadband network gateway. The method includes: receiving a hypertext transfer protocol (HTTP) request from a service portal, the HTTP request including a user profile; selecting a script based on the HTTP request; and executing the script, wherein the script calls a subscriber management application programming interface (API) and updates a host based on the user profile. Various exemplary embodiments relate to a broadband network gateway. The broadband network gateway includes: a hypertext transfer protocol server configured to receive an HTTP request from a web portal; an application programming interface providing a set of subscriber management functions of the broadband network gateway; and a script engine configured to extract parameters from the HTTP request and execute a preconfigured script making calls to the set of subscriber management functions using the extracted parameters.

### TECHNICAL FIELD

Various exemplary embodiments disclosed herein relate generally to communications networks.

### BACKGROUND

Network operators use a broadband network gateway (BNG) to process network traffic between the network operator's access network and core network. The BNG aggregates network traffic from and to residential subscribers. The BNG may be an enforcement point for network policy regarding subscriber services and usage.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a broadband network gateway. The method includes receiving a hypertext transfer protocol (HTTP) request from a service portal, the HTTP request including user information; selecting a script based on the HTTP request; and executing the script, wherein the script calls a subscriber management application programming interface (API) and performs a subscriber management action based on the user information.

In various embodiments, the user information is a user profile including host configuration information, wherein the subscriber management action includes configuring a host assigned to the user with the host configuration information. The method may further include receiving a request from a client device; generating a default profile for the client device, the default profile providing access to only the service portal; and assigning a host with the default profile to the client device, wherein the script makes a call to the API that updates the default profile with the user profile, the user profile providing access to the service portal and additional resources. The method may further include receiving an HTTP request from the client device and providing an HTTP redirect to the service portal.

In various embodiments, the broadband network gateway is a router comprising a plurality of physical ports interconnected by a fabric switch. The method may further include processing data packets from the client device according to the user profile.

In various embodiments, the the HTTP request is one of a simple object access protocol (SOAP) message and a representational state transfer (RESTful) message. In various embodiments, the script is a Python common gateway interface (CGI) script.

In various embodiments, the subscriber management action includes sending the user information to a RADIUS server and receiving a user profile from the RADIUS server.

In various embodiments, the method further includes receiving a new script via an operator interface.

Various exemplary embodiments relate to the above method encoded as instructions executable by a processor on a non-transitory machine-readable storage medium.

Various exemplary embodiments relate to a broadband network gateway. The broadband network gateway includes: a hypertext transfer protocol (HTTP) server configured to receive an HTTP request from a web portal; an application programming interface providing a set of management functions of the broadband network gateway; and a script engine configured to extract parameters from the HTTP request and execute a preconfigured script making calls to the set of management functions using the extracted parameters.

In various embodiments, the broadband network gateway further includes a host information storage configured to store information regarding a host corresponding to a client device, wherein the script engine is configured to update the host information storage using the subscriber management functions. The broadband network gateway may further include a plurality of line cards; a fabric switch interconnecting the line cards; and a deep packet inspection device. The line cards and deep packet inspection device may be configured to process packets received from the client device according to the host information storage.

It should be apparent that, in this manner, various exemplary embodiments enable a broadband network gateway to process HTTP requests received from a service portal. In particular, by using a script engine to call a subscriber management API, the broadband network gateway may allow a network operator to provide expanded functionality for the broadband network gateway.

### BRIEF DESCRIPTION OF THE DRAWINGS

In order to better understand various exemplary embodiments, reference is made to the accompanying drawings, wherein:

FIG. 1 illustrates a network diagram showing an exemplary communications network;

FIG. 2 illustrates a schematic diagram showing an exemplary broadband network gateway;

FIG. 3 illustrates a message diagram showing an exemplary method of providing services to a client; and

FIG. 4 illustrates a message diagram showing an exemplary method of updating services for a client.

### DETAILED DESCRIPTION

Referring now to the drawings, in which like numerals refer to like components or steps, there are disclosed broad aspects of various exemplary embodiments.

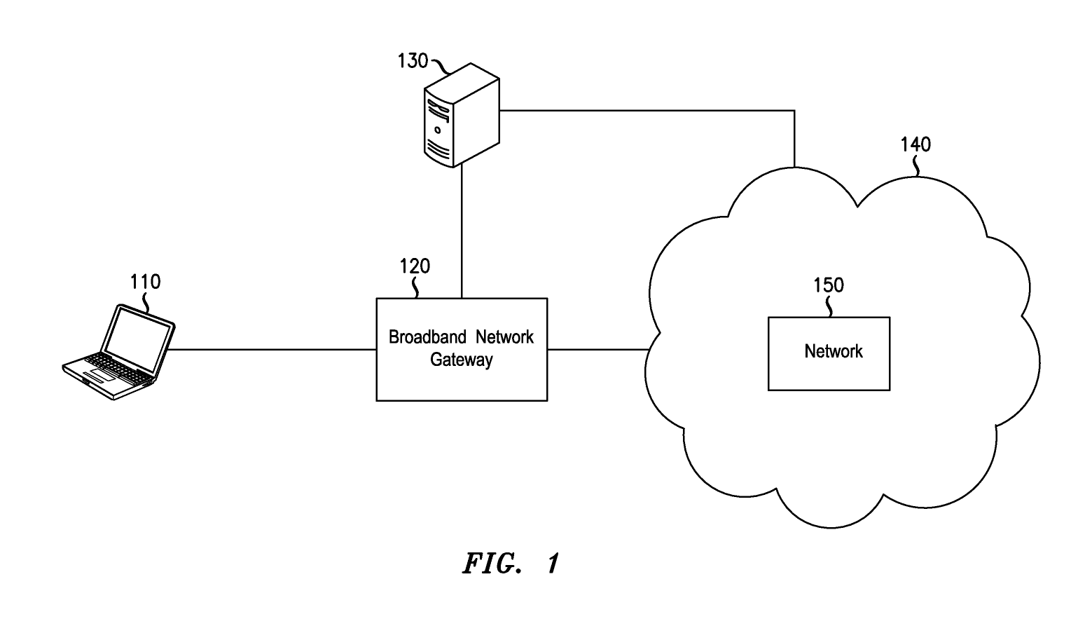

FIG. 1 illustrates a network diagram showing an exemplary communications network 100. Communications network 100 may be a subscriber network configured to provide user equipment (UE) 110 with access to a network 140, which may include Internet access. Communications network 100 may include one or more UE 110, broadband network gateway (BNG) 120, RADIUS server 130, network 140, and service portal 150 as well as various intermediate network devices (not shown).

UE 110 may include any device capable of data communications with network 140. For example, UE 110 may be a personal computer, laptop computer, tablet, or smart phone. In various embodiments, UE 110 may also include a user controlled router, switch, or hub, or other residential gateway. UE 110 may be configured to communicate using known protocols. For example, UE 110 may use dynamic host configuration protocol (DHCP) for address configuration to establish an internet protocol (IP) connection. UE 110 may use hypertext transfer protocol (HTTP) for requesting and receiving content from network 140.

UE 110 may be connected to broadband network gateway 120 via various intermediate devices. The intermediate devices may depend on the configuration of the access network. For example, the access network may use digital subscriber line, cable, fiber-optic, or broadband wireless for the last mile connection to UE 110. Accordingly, network 100 may include appropriate network devices for providing access to multiple UE 110 and aggregating communications toward BNG 120.

BNG 120 may be a network device configured to provide access to a network operator's core network. BNG 120 may also be referred to as a broadband remote access server (BRAS) or an edge router. BNG 120 may be configured to establish network connections and enforce quality of service (QoS) policies. As will be described in further detail below, BNG 120 may configured to communicate with an external device such as service portal 150. BNG 120 may include an HTTP server that receives HTTP messages from service portal 150. BNG 120 may respond to HTTP messages by executing network operator specified scripts in order to perform various management operations. An application programming interface (API) may determine the functions of BNG 120 that may be performed using scripts.

RADIUS server 130 may be a policy server configured to make policy decisions for network 100. RADIUS server 130 may provide authentication, authorization, and accounting for network 100. RADIUS server 130 may communicate with BNG 120 using remote access dial in user service (RADIUS). In various prior art networks, a RADIUS server 130 may be the only control point for BNG 120. In various exemplary embodiments, RADIUS server 130 may continue to be used in conjunction with a service portal 150. In various exemplary embodiments, RADIUS server 130 may not be present in network 100.

Network 140 may be any network for providing data communications between user equipment 110 and other devices connected to network 140, such as service portal 150. For example, network 140 may be the Internet.

Service portal 150 may be a device configured to provide a subscriber with information and control over a subscriber account with a network provider. For example, service portal 150 may be a server configured to provide a network provider website that allows a subscriber to make changes to the account. Service portal 150 may also provide for subscriber authentication, authorization and accounting. Service portal 150 may be connected to and communicate over network 140.

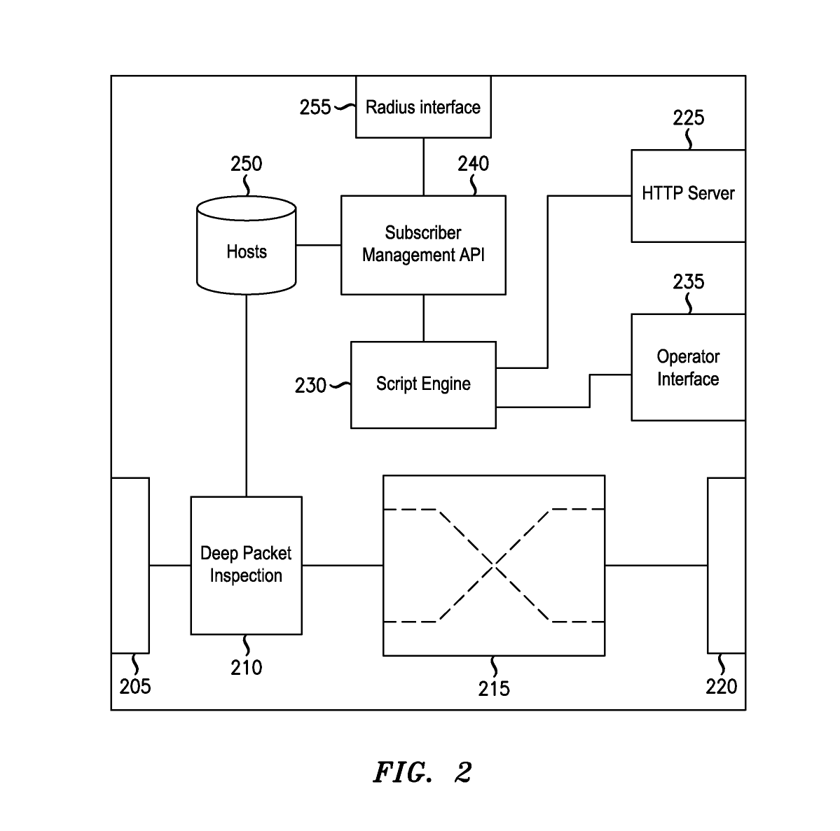

FIG. 2 illustrates a schematic diagram showing an exemplary broadband network gateway (BNG) 120. BNG 120 may be configured to provide a network operator with the ability to control various aspects of the operation of BNG 120. As will be described in further detail below, BNG 120 may provide an application programming interface and script engine that allow a network operator to create custom applications for managing BNG 120. BNG 120 may include ingress ports 205, a deep packet inspection device 210, a fabric switch 215, egress ports 220, a HTTP server 225, a script engine 230, an operator interface 235, a subscriber management API 240, a host information storage 250, and a RADIUS interface 255.

Ingress ports 205 may include one or more network interfaces or line cards that receive data packet traffic from network devices. Ingress ports 205 may perform initial processing of received data packets. For example, ingress ports 205 may apply filters to the received packets according to configuration information in host information storage 250. Ingress ports 205 may also control packet queuing, priority and bandwidth. Ingress ports 205 or a connected control plane module may include routing tables indicating the destination port for a packet based on a network address. Fabric switch 215 may include a device configured to transfer packets to the correct output port 220. Output ports 220 may include one or more network interfaces or line cards that transmit packets to other network devices. Output ports 220 may also perform processing of received data packets according to configuration information. In various embodiments, output ports 220 may be the same physical devices as ingress ports 205.

Deep packet inspection (DPI) device 210 may be a device configured to inspect and provide control over network traffic. DPI device 210 may analyze incoming network traffic and apply policies based on host configuration information 250. In various embodiments, DPI device 210 may recognize packets sent from a UE 100 that has been configured with a default host profile and redirect the UE 100 to service portal 150. DPI device 210 may provide other policy based control such as traffic shaping and application assurance.

HTTP server 225 may include hardware or processor executable instructions encoded on a machine-readable storage medium configured to communicate with a client using hypertext transmission protocol. In various embodiments, the client may be service portal 150. Accordingly, HTTP server 225 may receive HTTP messages from service portal 150. In various embodiments, HTTP server 225 may be configured to receive simple object access protocol (SOAP) messages or representational state transfer (RESTful) messages. Such HTTP messages may include objects such as user profiles, user identification, or credentials that may be used by BNG 120.

Receiving HTTP messages may provide for a reliable and secure connection with an external device located in network 140. A web server, such as service portal 150, may already communicate using HTTP and be able to easily communicate with BNG 120. HTTPS may be used for security. HTTP may use transmission control protocol (TCP) rather than the less reliable user datagram protocol (UDP)

Script engine 230 may include hardware or processor executable instructions encoded on a machine-readable storage medium configured to execute a script. In various embodiments, script engine 230 may provide a common gateway interface (CGI) or simple common gateway interface (SCGI) for HTTP server 225. In various embodiments, script engine 230 may execute scripts written in a scripting language such as Python, although it should be apparent that any scripting language may be used.

Operator interface 235 may include hardware or processor executable instructions encoded on a machine-readable storage medium configured to enable a network operator to configure script engine 230. For example, operator interface 235 may include an input device and monitor that allow a network operator to write a new script executable by script engine 230. An network operator may use operator interface 235 to add, delete, or modify scripts while BNG 120 is deployed in the field. Accordingly, operator interface and script engine 230 may be used to provide new functionality for BNG 120 without changes to the underlying operating system of BNG 120. Operator interface 235 may also include a network interface that allows a network operator remote access to BNG 120.

Subscriber management application programming interface (API) 240 may include hardware or processor executable instructions encoded on a machine-readable storage medium configured to provide limited access to various functionality of BNG 120 while keeping other functionality protected from change. Subscriber management API 240 may be integrated with the operating system of BNG 120 provided by a vendor to the network operator. Accordingly, the network operator may be able to use but not directly change the API 240. Subscriber management API 240 may allow a script to perform various subscriber management actions. For example, the subscriber management API 240 may make various changes to subscriber information used by BNG 120. For example, subscriber management API 240 may allow a script to create a new host, modify user profiles, remove a host, send HTTP messages, or perform other functions. In various embodiments, the subscriber management API may provide functions that communicate with a RADIUS server 130 for performing the management functions. Accordingly, BNG 120 may remain compatible with existing networks using a RADIUS server 130.

While a subscriber management API 240 that performs various subscriber account management actions has been described, a subscriber management action may include any BNG function that affects a subscriber and BNG 120 may include one or more APIs that perform additional management functions. BNG 120 may include an API for any functionality of BNG 120 that a network operator may want to use or modify. A network operator may provide scripts that perform tasks that might normally be performed by a human operator such as custom configuration. For example, BNG 120 may provide an API that may be used to configure DPI device 210 with various application aware features. In such an embodiment, HTTP server 225 may communicate with a service portal or other external device to provide application related information or allow requests from application providers. Accordingly, such an API may allow a network operator to provide a web application at the service portal for configuration of application specific processing.

As another example, BNG 120 may include a network address translation (NAT) API. The NAT API may, for example, provide functions for configuring NAT processing for a subscriber or client device. The NAT API may be used for opening a static NAT port. The subscriber may login to a service portal and define the static port forwarding. The service portal 150 may then send an HTTP request to the BNG 120. The script engine 230 may then execute a NAT configuration script to process the HTTP request and call the NAT API.

As yet another example, BNG 120 may allow for VPN configuration. A network operator or information technology specialist for a enterprise may use service portal 150 to request a VPN service and provide enterprise side information. The service portal may then provide the request to BNG 120 as an HTTP request. The script engine 230 may then call a VPN API to configure the VPN service. The use of an API and script may allow for dynamic VPN configuration on demand.

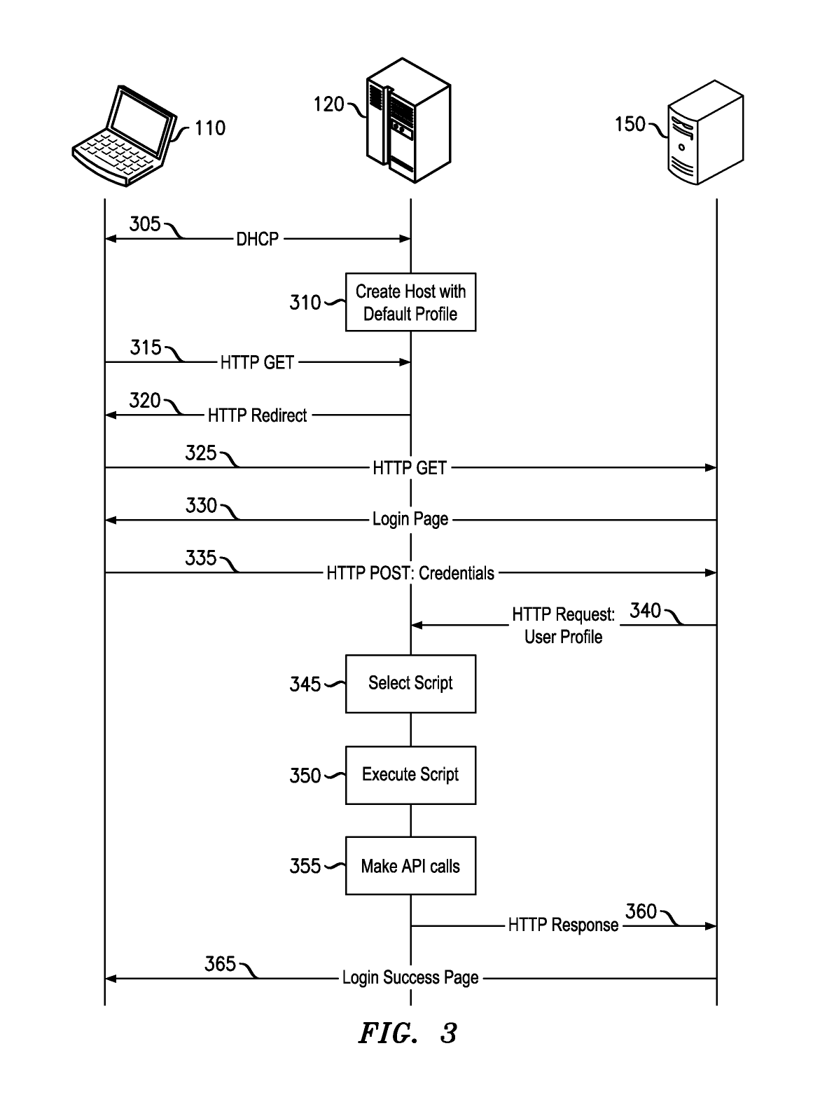

Host information storage 250 may include a machine-readable storage medium configured to store information regarding a host for each UE 110. Host information storage 250 may include a user profile including configuration information for processing traffic for the user. For example, the user profile may include QoS limits, usage quotas, and charging information. Various components of BNG 120, such as DPI device 210 may access host information storage 250 when processing user traffic. FIG. 3 illustrates a message diagram showing an exemplary method 300 of providing services to a client. The method 300 may be performed by network nodes including UE 110, BNG 120, and service portal 150. The arrows in FIG. 3 may represent one or more messages sent between network nodes. It should be appreciated that an arrow may represent both steps of sending and receiving a message.

In step 305, UE 110 may establish a connection with BNG 120 using DHCP. BNG 120 may assign an IP address to UE 110.

In step 310, BNG 120 may create a host with a default profile for the UE 110. The default profile may provide only limited services for the UE 110. For example, the default profile may only allow traffic between UE 110 and service portal 150. The default profile may also include instructions to redirect any requests from UE 110 to service portal 150. In step 315, UE 110 may send an HTTP get request to BNG 120. The HTTP get request may be addressed to any web server. BNG 120 may process the HTTP get request according to the default profile. Accordingly, in step 320, BNG 120 may send an HTTP redirect to UE 110 indicating the service portal 150.

In step 325, UE 110 may send an HTTP get request addressed to service portal 150 based on the HTTP redirect. When BNG 120 receives the second HTTP get, BNG 120 may forward the request along to service portal 150 according to the default profile. In step 330, the service portal 150 may send a login page to the UE 110. The login page may include fields for a user to enter a username and password associated with a subscriber account. In step 335, the user may fill the requested fields and send an HTTP Post request with the credentials. The service portal 150 may verify the credentials and the subscriber's account.

In step 340, the service portal 150 may send an HTTP request to BNG 120. The HTTP request may include a user identification and profile for the subscriber. The user profile may include any information necessary for the BNG 120 to provide service to the UE 110. For example, the user profile may include QoS limits, usage quotas, charging information and any other subscriber information. The HTTP request may also indicate an action that should be taken by the BNG 120. For example, the request may indicate that the BNG 120 should update the user profile. In various embodiments, the HTTP request may be a simple object access protocol (SOAP) message or a representational state transfer (RESTful) message. Any other protocol for communicating information within an HTTP request may also be used.

In step 345, BNG 120 may select a script to execute based on the received HTTP request. BNG 120 may determine the requested action included in the HTTP request and select a script to perform the requested action. In step 350, BNG 120 may execute the script. The script may include instructions for authenticating the HTTP request and the service portal 150. In step 355, the script may make an API call to perform subscriber management actions. For example, the script may call an API function to verify the existence of the host for the UE 110. The script may then call an API to update the host with the user profile received in the HTTP request.

In various embodiments, the API calls may include functions that interact with a RADIUS server 130. For example, the API may communicate with the RADIUS server 130 to authenticate the user profile before updating the default profile. Accordingly, the BNG 120 may rely on the RADIUS server 130 for authentication in addition to the service portal. The BNG 120 may include API functions that perform the same management functions both with and without interaction with a RADIUS server 130. Accordingly, a network operator may use BNG 120 to eliminate the need for a RADIUS server 130. On the other hand, a network operator may pick and choose management functions that interact with the RADIUS server 130. For example, the network operator may use the RADIUS server 130 for accounting purposes, but allow login from the service portal without communicating with the RADIUS server 130. In step 360, the script may generate an HTTP response based on the result of the API calls. For example, the HTTP response may indicate that the user profile was successfully updated. In step 365, the service portal 150 may send the UE 110 a login success page. The login success page may include information regarding the network 100, the user account, and a link to the originally requested page. The method 300 may then end.

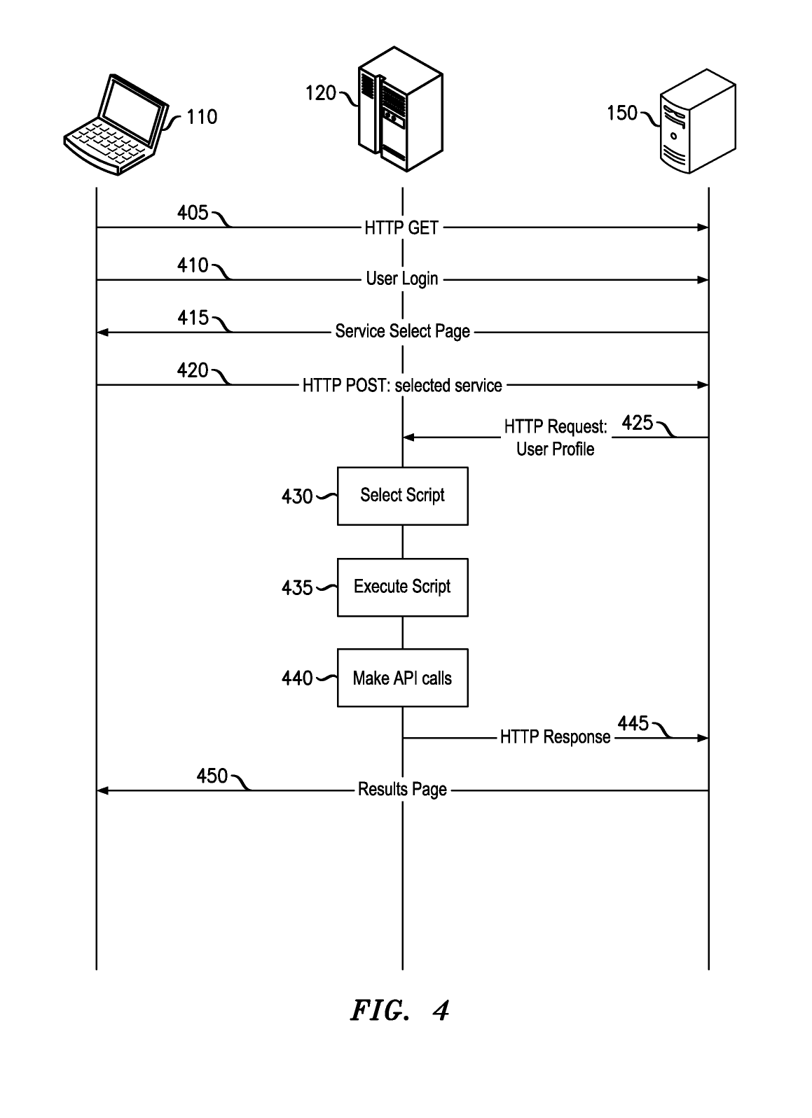

FIG. 4 illustrates a message diagram showing an exemplary method of updating services for a client. The method 400 may be performed by network nodes including UE 110, BNG 120, and service portal 150. The arrows in FIG. 4 may represent one or more messages sent between network nodes. It should be appreciated that an arrow may represent both steps of sending and receiving a message. The method 400 may be performed after the method 300. Alternatively, the method 400 may be performed whenever UE 110 has already established network connectivity. The method 400 may begin at step 405, where a UE 110 may send an HTTP get request for a web page from the service portal 150. The BNG 120 may process the request and forward the packets according to a user profile stored for the UE 110. In step 410, the UE 110 and service portal 150 may complete a user login process by sending one or more messages. For example, the UE 110 may send a username and password. The BNG 120 may process each message and forward toward the appropriate destination.

In step 415, the service portal 150 may send a service select page to the UE 110. The service select page may include available options of one or more services available to the UE 110. For example, the service select page may allow the user to change account QoS settings or usage quotas. In step 420, the UE 110 may send a HTTP post message with selected service information. The HTTP post message may also include payment information or any other information necessary to change the user's services.

In step 425, the service portal 150 may send an HTTP request to BNG 120. The HTTP request may include an updated user profile for the subscriber. The user profile may include any information necessary for the BNG 120 to update the services for the UE 110. For example, the user profile may include QoS limits, usage quotas, charging information and any other subscriber information. The HTTP request may also indicate an action that should be taken by the BNG 120. For example, the request may indicate that the BNG 120 should update the user profile. In various embodiments, the HTTP request may be a simple object access protocol (SOAP) message or a representational state transfer (RESTful) message. Any other protocol for communicating information within an HTTP request may also be used.

In step 430, BNG 120 may select a script to execute based on the received HTTP request. BNG 120 may determine the requested action included in the HTTP request and select a script to perform the requested action. In step 435, BNG 120 may execute the script. The script may include instructions for authenticating the HTTP request and the service portal 150. In step 440, the script may make an API call to perform subscriber management actions. For example, the script may call an API function to verify the existence of the host for the UE 110. The script may then call an API to update the host with the user profile received in the HTTP request.

In various embodiments, the API calls may include functions that interact with a RADIUS server 130. For example, the API may communicate with the RADIUS server 130 to authorize the changes in updating the user profile. The BNG 120 may include API functions that perform the same management functions both with and without interaction with a RADIUS server 130. Accordingly, a network operator may use BNG 120 to eliminate the need for a RADIUS server 130. On the other hand, a network operator may pick and choose management functions that interact with the RADIUS server 130. For example, the network operator may use the RADIUS server 130 for accounting purposes, but allow login from the service portal without communicating with the RADIUS server 130.

In step 445, the script may generate an HTTP response based on the result of the API calls. For example, the HTTP response may indicate that the user profile was successfully updated. In step 450 the service portal 150 may send the UE 110 a results page. The results page may include a summary of any changes to the user account selected by the user. The results page may serve a receipt for the user. The method 400 may then end.

According to the foregoing, various exemplary embodiments provide for a broadband network gateway to process HTTP requests received from a service portal. In particular, by using a script engine to call a subscriber management API, the broadband network gateway may allow a network operator to provide expanded functionality for the broadband network gateway.

It should be apparent from the foregoing description that various exemplary embodiments of the invention may be implemented in hardware and/or software running on a processor. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a broadband network gateway, the method comprising:
receiving a hypertext transfer protocol (HTTP) request from a service portal, the HTTP request including user information;
selecting a script based on the HTTP request; and
executing the script, wherein the script calls a subscriber management application programming interface (API) and performs a subscriber management action based on the user information.

2. The method of claim 1, wherein the user information is a user profile including host configuration information, wherein the subscriber management action comprises configuring a host assigned to the user with the host configuration information.

3. The method of claim 2, further comprising:
receiving a request from a client device;
generating a default profile for the client device, the default profile providing access to only the service portal; and
assigning a host with the default profile to the client device,
wherein the script makes a call to the API that updates the default profile with the user profile, the user profile providing access to the service portal and additional resources.

4. The method of claim 3, further comprising receiving an HTTP request from the client device and providing an HTTP redirect to the service portal.

5. The method of claim 2, wherein the broadband network gateway is a router comprising a plurality of physical ports interconnected by a fabric switch.

6. The method of claim 5, further comprising processing data packets from the client device according to the user profile.

7. The method of claim 1, wherein the HTTP request is one of a simple object access protocol (SOAP) message and a representational state transfer (RESTful) message.

8. The method of claim 1, wherein the script is a Python common gateway interface (CGI) script.

9. The method of claim 1, wherein the subscriber management action comprises sending the user information to a RADIUS server and receiving a user profile from the RADIUS server.

10. The method of claim 1, further comprising receiving a new script via an operator interface.

11. A broadband network gateway comprising:
a hypertext transfer protocol (HTTP) server configured to receive an HTTP request from a web portal;
an application programming interface providing a set of management functions of the broadband network gateway; and
a script engine configured to extract parameters from the HTTP request and execute a preconfigured script making calls to the set of management functions using the extracted parameters.

12. The broadband network gateway of claim 11, further comprising a host information storage configured to store information regarding a host corresponding to a client device, wherein the script engine is configured to update the host information storage using the subscriber management functions.

13. The broadband network gateway of claim 12, further comprising a plurality of line cards; a fabric switch interconnecting the line cards; and a deep packet inspection device.

14. The broadband network gateway of claim 13, wherein the line cards and deep packet inspection device are configured to process packets received from the client device according to the host information storage.

15. A non-transitory machine-readable storage medium encoded with instructions executable by a processor of a broadband network gateway, the non-transitory machine-readable storage medium comprising instructions for:
receiving a hypertext transfer protocol (HTTP) request from a service portal, the HTTP request including a user profile;
selecting a script based on the HTTP request; and
executing the script, wherein the script calls a subscriber management application programming interface (API) and performing a subscriber management action based on the user profile.

16. The non-transitory machine-readable storage medium of claim 15 further comprising instructions for:
receiving a request from a client device;
generating a default profile for the client device, the default profile providing access to only the service portal; and
assigning the host and the default profile to the client device,
wherein the script makes a call to the API that updates the default profile with the user profile, the user profile providing access to the service portal and additional resources.

17. The non-transitory machine-readable storage medium of claim 16 further comprising instructions for receiving an HTTP request from the client device and providing an HTTP redirect to the service portal.

18. The non-transitory machine-readable storage medium of claim 15, wherein the HTTP request is one of a simple object access protocol (SOAP) message and a representational state transfer (RESTful) message, and the script is a Python common gateway interface (CGI) script.

19. The non-transitory machine-readable storage medium of claim 15, wherein the API communicates with a RADIUS server.

20. The non-transitory machine-readable storage medium of claim 15 wherein the broadband network gateway is a router comprising a plurality of physical ports interconnected by a fabric switch, the non-transitory machine-readable storage medium further comprising instructions for processing data packets from the client device according to the user profile.
